(19) United States
(12) Patent Application Publication
(10) Pub. No.: US 2008/0228379 A1
(43) Pub. Date: Sep. 18, 2008

(54) Method and device for detecting the fuel quality in an internal combustion engine

(76) Inventor: Oliver Brox, Korntal-Muenchingen (DE)

Correspondence Address: KENYON & KENYON LLP, ONE BROADWAY, NEW YORK, NY, 10004, US

(21) Appl. No.: 12/075,826

(22) Filed: Mar. 13, 2008

(30) Foreign Application Priority Data
Mar. 14, 2007 (DE) 102007012309.6

(51) Int. Cl. F02D 41/00

(52) U.S. Cl. 701/106; 73/114.38; 73/53.01

(57) ABSTRACT

A device and a method for detecting the fuel quality in an internal combustion engine, especially a Diesel internal combustion engine. At particular operating states, in at least one cylinder, a start of injection is changed based on a starting value, and it is checked whether combustion takes place. Based on whether a combustion takes place or not, a combustion limit is ascertained and used as a measure for the quality of the fuel.

### BACKGROUND INFORMATION

Demands on modern internal combustion engines are rising continually, particularly in the automotive field and especially in the case of Diesel internal combustion engines. This is based on legal boundary conditions, on the one hand, with regard to admissible emission limiting values, and on the other hand on increased expectations on the part of the end user with respect to riding comfort, smooth running and lower usage.

Accurate control of fuel combustion is essential to fulfill these requirements. In the Diesel engine this takes place via a targeted control of the composition of the cylinder charge made up of fresh air and recycled exhaust gas, the injection quantity and the start of injection. The deviation of one of these variables immediately leads to a change in the ignition retard, and thus to a shift in the combustion position, the emissions and the torque generated. These variables then no longer agree with their setpoint values.

This fault version may also be created even when the above parameters are maintained. The variation of the quality of the fuel, in particular, has a massive effect on the shift in the combustion position. This interrelationship is a problem especially in countries having strict exhaust gas limiting values and fluctuating fuel quality.

### SUMMARY OF THE INVENTION

Using the procedure according to the present invention, in which in particular operating states, in at least one cylinder, the start of injection is changed starting from a starting value, and it is checked whether combustion is taking place, and depending on whether combustion is taking place, a combustion limit is ascertained and is used as a measure of the fuel quality. Using this procedure according to the present invention, with no usefulness of an additional sensor, particularly a combustion chamber sensor, the quality of the injected fuel may be detected. The cetane number may be ascertained in this way, in particular.

The starting value may be selected so that combustion takes place, in this context. In this case, the start of injection is preferably changed in the late direction, until no further combustion takes place.

In a second specific embodiment, the starting value is selected so that no combustion takes place. In this case, the start of injection is preferably changed in the early direction, until combustion takes place again.

Since this change in the start of injection takes place in only one cylinder, an absent combustion is very easily detected. This detection preferably takes place by the evaluation of a correction factor of a function which carries out a cylinder equalization. If the combustion is omitted in the cylinder in which the start of injection is changed, this may be detected very easily and certainly by the correction value assigned to this cylinder.

It is particularly advantageous that this determination is carried out in response to certain specified conditions of the internal combustion engine. Such particularly advantageous specific conditions are present if the internal combustion engine is in a hot state, that is, the engine temperature exceeds a certain threshold value. Furthermore, it is especially advantageous if the checking is carried out in the operating state of idling. Moreover, it is particularly advantageous that, during the checking, the exhaust-gas recirculation as well as the advanced injection are switched off.

It is particularly advantageous if, starting from a starting value in which combustion takes place, the start of injection is shifted in the late direction. This takes place until combustion fails to happen. This start of injection, at which combustion fails to happen, is detected as being the combustion limit. This combustion limit is a measure for the quality of the fuel, and thus the cetane number.

### BRIEF DESCRIPTION OF THE DRAWINGS

FIG. 1 shows a schematic representation of the internal combustion engine including its controller.

FIG. 2 shows a flow chart for clarifying the procedure according to the present invention.

### DETAILED DESCRIPTION

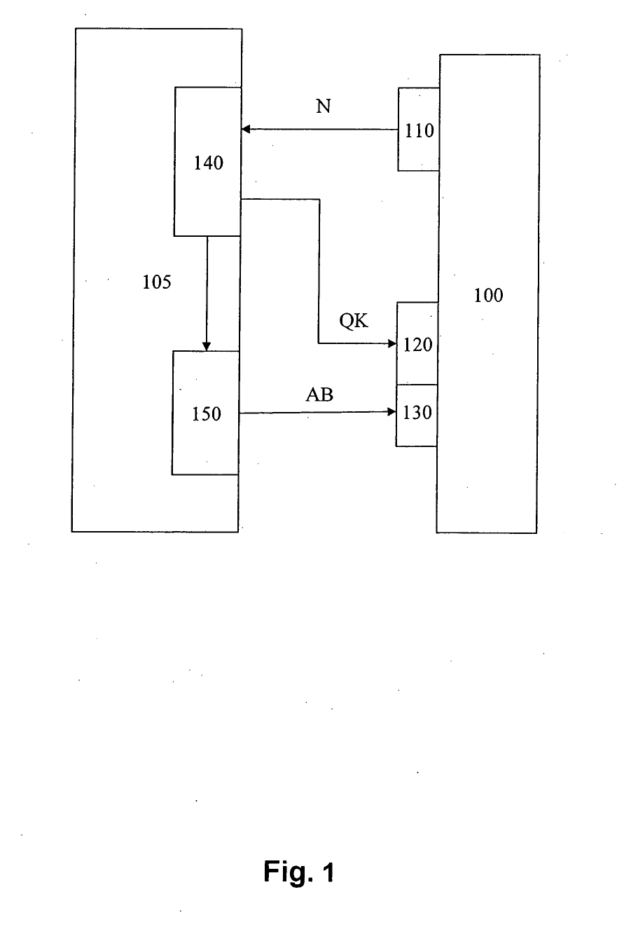

In FIG. 1 an internal combustion engine is designated by 100 and an appertaining control unit by 105. Various sensor 110 are assigned to the internal combustion engine, which provide signals which characterize the operating state of the internal combustion engine. Signal N which characterizes the rotary speed of the internal combustion engine is such a signal, for instance. Sensor 110 provides this signal N to control unit 105. In addition, control elements 120 and 130 are provided, by which various operating variables, such as start of injection AB and quantity of injection QK are able to be set. As a function of actuating signal AB and actuating signal QK, control elements 120 and 130 provide to the internal combustion engine the fuel quantity QK requested by control unit 105 at the point in time, requested by the control unit, or at the angular position of the crankshaft. It may also be provided, in this context, that the control elements be developed as actuating elements. Thus, for instance, in the case of a fuel injector of a common-rail system a solenoid valve or a piezo actuator controls both the start of injection and the injection quantity.

Besides various functional units, control unit 105 includes among other things a quantity equalization controller 140. This quantity equalization controller evaluates rotary speed signal N of sensor 110, the speed differences of the individual cylinders being evaluated, and, based on the speed differences, conclusions are reached on different injected fuel quantities and different torque contributions of the individual cylinders. Based on the deviation of the individual cylinders, fuel quantity QK of the individual cylinders is correspondingly corrected. Such a quantity equalization controller is known from, and described in German Patent No. DE 33 36 028, for example.

Furthermore, a device 150 is provided for detecting the fuel quality. This influences signal AB, which influences the start of injection and observes the reaction of quantity equalization controller 140. Quality detection 150 detects the fuel quality based on the reaction of the quantity equalization controller. To do this, it proceeds as follows:

If a defined operating state of the internal combustion engine is present, then, starting from a value of the start of injection, the latter is changed until a reaction occurs in the quantity equalization controller. In one particularly advantageous embodiment it is provided that, as the starting value, that value of the start of injection be selected that is normally used under the present conditions. Based on this starting value, the start of injection in one cylinder of the internal combustion engine is then shifted in the late direction, that is, in this cylinder the injection takes place at a later time than in the remaining cylinders. This shifting of the start of injection takes place until the fuel in this combustion chamber no longer ignites. Such a failure of the combustion to occur is preferably detected in that quantity equalization controller 140 detects that in one cylinder of the internal combustion engine a clearly increased correction value has appeared.

It may also be provided according to the present invention that such an omitted combustion be detected by other sensors or other evaluation principles. Alternatively, it may also be provided that a value for the start of ignition be selected as the starting value, at which certainly no combustion occurs and the start of injection is shifted in the direction of an earlier injection, until combustion takes place.

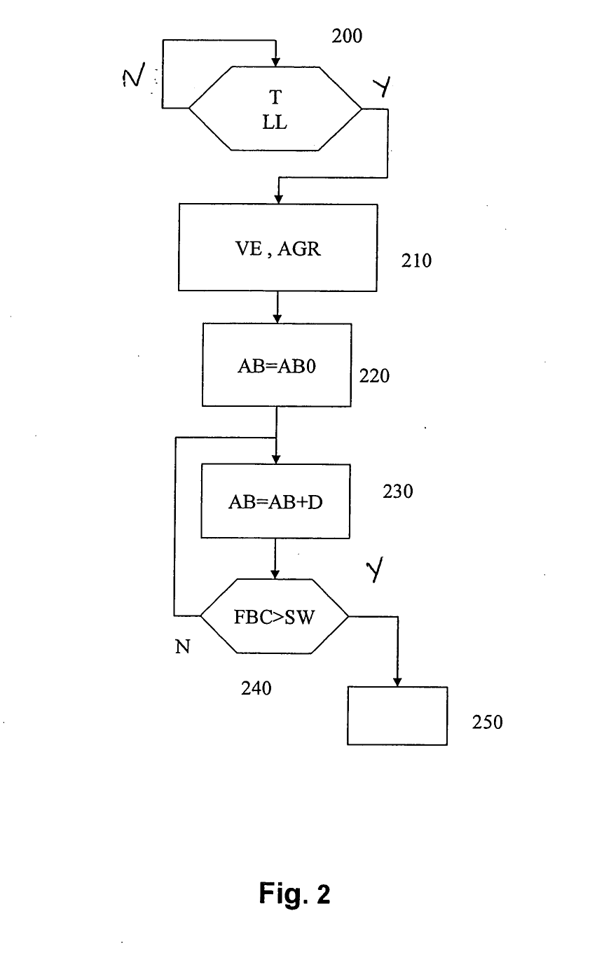

FIG. 2 shows by an example the procedure according to the present invention, using a flow chart. In a first step 200, it is checked whether an operating state exists in which the fuel quality is able to be ascertained. Thus, in query 200 it is checked whether the internal combustion engine is idling. If this is not the case, query 200 is repeated. If it is the case, step 210 follows next. In addition or alternatively, it may also be queried in step 200 whether the internal combustion engine has already reached its operating temperature, that is, it is checked in query 200 whether the engine temperature is greater than a threshold value. It is ensured by this query that the method is carried out only on an engine having operational temperature, so that no unnecessary faulty interpretations take place. It is particularly advantageous if the method is carried out only on engines that are at operating temperature and are idling. This has the advantage that, during idling, the effect on the vehicle performance of the vehicle driven by the internal combustion engine is slight.

In step 210, the exhaust gas recirculation and/or the advanced injection are switched off. This takes place with the background that in an operating state not having exhaust gas recirculation and not having advanced injection, the effect of the fuel quality on the combustion process is greater and defined. In one alternative specific embodiment it may be provided that only the advanced injection, or alternatively only the exhaust gas recirculation be switched off. Moreover, it may be provided in other specific embodiments that additional regulations or controls should be taken out of operation. It is especially provided that the method should not be carried out if the internal combustion engine is in a special operating state in which, for example, an exhaust gas aftertreatment system is being regenerated.

In subsequent step 220, start of injection AB is set to a starting value ABO. Thereafter, in step 230 a new start of injection AB is calculated by increasing the old value by a certain value D, that is, the new beginning of injection is shifted to late compared to the original starting value, i.e. the injection takes place at a later time. Subsequent query 240 checks whether correction value FBC of the quantity equalization controller exceeds a certain threshold value SW for this respective cylinder. This threshold value is preferably selected so that it is detected when combustion fails to materialize. If this is not the case, the start of injection is set to late some more, in a step 230. By contrast, if query 240 detects that the correction value of quantity equalization controller FBC is greater than threshold value SW, the program ends at step 250. In step 250 the start of injection, using which, correction value FBC of the quantity equalization controller is greater than the threshold value, is stored as the combustion limit. Starting from this combustion limit, that is, at the value for the start of injection at which combustion does not materialize, the fuel quality, particularly the cetane number, is then ascertained. In doing this one may make use of the property that, as a function of the cetane number, combustion still takes place at different starts of ignition or it already does not materialize, i.e. the point in time or the angular position of the crankshaft at which, under specified conditions, there is just no further combustion, is used as the combustion limit and as a quality criterion for the fuel quality.

This variable thus ascertained is then used for controlling the internal combustion engine and for the corresponding correction of different variables.

What is claimed is:

1. A method for detecting the quality of fuel in an internal combustion engine, comprising:
at particular operating states, in at least one cylinder, changing a start of injection based on a starting value;
checking whether a combustion takes place; and
based on whether a combustion takes place or not, ascertaining a combustion limit and using the combustion limit as a measure for the quality of the fuel.

2. The method according to claim 1, wherein the engine is a Diesel internal combustion engine.

3. The method according to claim 1, wherein a state is used as the particular operating state in which an engine temperature exceeds a specified threshold value.

4. The method according to claim 1, wherein idling operation is used as the particular operating state.

5. The method according to claim 1, further comprising switching off at least one of an exhaust gas recirculation and an advanced injection in the particular operating state.

6. The method according to claim 1, further comprising shifting the start of injection in a late direction based on a starting value.

7. The method according to claim 1, wherein a value of the start of injection at which a quantity equalization controller indicates that, in the at least one cylinder, no further combustion is taking place, is used as the combustion limit.

8. A device for detecting the quality of fuel in an internal combustion engine, comprising:
means for changing, at particular operating states, in at least one cylinder, a start of injection based on a starting value;
means for checking whether a combustion is taking place; and
means for ascertaining, based on whether a combustion takes place or not, a combustion limit and for using the combustion limit as a measure for the quality of the fuel.

9. The device according to claim 8, wherein the engine is a Diesel internal combustion engine.
